(19) United States
(12) Patent Application Publication
(10) Pub. No.: US 2026/0238938 A1
(43) Pub. Date: Aug. 13, 2026

(54) Bone Conduction Headset with Transcutaneous Electrical Nerve Stimulation Function

(71) Applicant: MIJ CO., LTD., Gangwon-do (KR)

(72) Inventor: Jin Suk HUR, Gangwon-do (KR)

(73) Assignee: MIJ CO., LTD., Gangwon-do (KR)

(21) Appl. No.: 19/150,125

(22) PCT Filed: Oct. 25, 2024
(86) PCT No.: PCT/KR2024/016434

§ 371 Date: Mar. 24, 2026

(30) Foreign Application Priority Data
Oct. 27, 2023 (KR) 10-2023-0145844

(51) Int. Cl. H04R 25/00

(52) U.S. Cl. CPC H04R 25/65; H04R 25/602; H04R 25/606; H04R 2225/31

(57) ABSTRACT

An electrically-stimulated bone conduction headset comprising: a neck band part, which surrounds, in a band shape, the back of the head of a user; earpiece parts, which are arranged on both ends of the neck band so as to be hung on the ears of the user; bone conduction parts, which are provided to be adjacent to the front ends of the earpiece parts; electrical stimulation parts which are spaced toward the back from the bone conduction parts and which have electrodes provided on the side surface thereof that comes in contact with the skin; and control parts for controlling the operations of the bone conduction parts and the electrical stimulation parts, and thus the present invention includes bone conduction parts and the electrical stimulation parts together such that hearing loss or tinnitus treatment can be effectively performed while speech is received through bone conduction.

### TECHNICAL FIELD

The present disclosure relates to an electrically-stimulated bone conduction headset, and more particularly, to an electrically-stimulated bone conduction headset including both bone conduction parts and electrical stimulation parts to have an excellent effect in preventing a hearing loss as well as in treating tinnitus through bone conduction.

### BACKGROUND ART

Generally, sound heard by a human ear is transmitted in a form of waves. External sound is input through a human outer ear, vibrates an eardrum, and stimulates cells in an inner ear inside the eardrum to be transmitted to a brain.

A frequency range of sound that humans can hear is approximately 20 to 20,000 Hz, and a frequency range of sound that humans use to converse with each other is approximately 500 to 2,000 Hz.

However, hearing impaired people may not be able to hear sound of all or some frequencies within a sound frequency range.

Therefore, recently, a bone conduction method such that sound is transmitted through vibration of a skull is being widely used.

The bone conduction method is performed by transmitting sound that vibrates through a skull to a cochlea, and then, to a brain via an auditory nerve. In this method, a process in which vibrations pass through an eardrum and three bones placed in the eardrum mechanism in a sound recognition mechanism is bypassed.

That is, a bone conduction headset transmits sound vibrations applied to a skin surface near ears directly to a cochlea through a skull. Thus, even hearing-impaired people caused by issues with eardrums or ossicles may clearly hear sound through bone conduction via skin and bones as long as cochlea and auditory nerves are normal.

Meanwhile, since ears are covered when an air conduction headset is used, ambient sound is not heard, and thus, a risk of safety accidents may be increased.

Accordingly, in advanced countries, it is legally prohibited to wear air conduction earphones or headphones used by blocking ears while listening to music on a road.

In addition, due to a rapid spread of digital audio and communication devices in recent years, hearing loss caused by noise among adolescents has increased to over 10% of a population worldwide. In addition, in an era of global aging, an increase in presbycusis has also become a social problem. Thus, as an alternative, reducing volume and usage time of speakers that receive sound via air conduction is being proposed.

Meanwhile, while a bone conduction headset is being used, ears may be kept open. Thus, since ambient sound may be simultaneously received, safety accidents may be prevented, and an eardrum is not directly affected, thereby preventing a hearing loss.

The bone conduction headset transmits sound by vibrating bones around ears, and thus, may be usefully used by hearing impaired people as well as people who work in noisy places.

Meanwhile, transcutaneous electrical nerve stimulation (TENS) is a method of treating various types of pain caused by diverse reasons by stimulating peripheral sensory nerves of skin using electric current of a certain frequency and intensity, and is applied to various parts of a body.

In detail, transcutaneous electrical nerve stimulation uses low-voltage modified normal current or low-frequency current, and a pulse frequency, a pulse width, and a stimulation intensity may be variously set depending on an applied body part or physical characteristics of each individual.

Although specifications of transcutaneous electrical nerve stimulation devices are diverse, settings of a current pulse frequency, a pulse width, a stimulation intensity, treatment time, a stimulation site, and an electrode placement method are important considerations when transcutaneous nerve stimulation treatment is performed.

For example, waveforms commonly used include a monophasic rectangular wave, an asymmetrical biphasic rectangular wave, a symmetrical biphasic rectangular wave, a modified spike wave, a monophasic rectangular high-frequency carrier wave, and a sine wave.

A pulse rate varies within a range of 10 to 200 pulses per second (pps), such as 10 to 100 pps or 20 to 200 pps, and may be generally set in a range of 1 to 100 pps. Thus, an appropriate pulse rate may be selected and adjusted to be used.

A pulse duration may vary within a range of 10 to 600<<S, for example, 10 to 200<<S, 120 to 330<<S, and 50 to 500<<S. An asymmetrical biphasic rectangular wave has a pulse width ranging from 50 to 500<<S, and a monophasic rectangular wave has a pulse width ranging from 10 to 100<<S.

A stimulus intensity varies, for example, 10 to 50 mA, 100 mA or less, or 150 mA or less, but usually, 100mA or less.

In addition, electrodes may vary in size and shape. Depending on materials, pad electrodes, carbon silicon electrodes, disposable paper electrodes, and Karaya gum electrodes may be used, and carbon silicon electrodes are commonly used.

A shape and size of the electrodes are also highly diverse and may include a snap type with a diameter of 5 cm, a pin type, a square type, a rectangular type, and a banana shape. Thus, an appropriate electrode according to characteristics of a treatment site may be selected and used.

Since the aforementioned transcutaneous electrical nerve stimulation is known to be effective for tinnitus, ear ringing, and hearing loss, a method of treatment by stimulating areas near ears have been performed recently.

### Prior art document

Korea Patent Registration No. 10-1849041

### DISCLOSURE OF INVENTION

Therefore, the present disclosure has been made in view of the above problems, and it is an object of the present disclosure is to provide an electrically-stimulated bone conduction headset including both bone conduction parts and electrical stimulation parts to have various effects in preventing a hearing loss through bone conduction as well as effectively treating tinnitus.

To accomplish the above-mentioned objects, according to one aspect of the present disclosure, there is provided an electrically-stimulated bone conduction headset comprising: a neck band part that surrounds, in a band shape, a back side of a head of a user; earpiece parts arranged on both ends of the neck band part and hung on ears of the user, respectively; bone conduction parts installed to be adjacent to front ends of the earpiece parts, respectively; electrical stimulation parts installed to be spaced apart from the bone conduction parts toward the back side and having an electrode installed on each of side surfaces which are in contact with skin; and a control part configured to control operations of the bone conduction parts and the electrical stimulation parts.

According to the present disclosure, desirably, the electrical stimulation parts are installed to be connected to rear ends of the earpiece parts.

According to the present disclosure, desirably, the electrical stimulation parts are configured to be separable from the earpiece parts.

According to the present disclosure, desirably, coupling holes are arranged in a vertical direction at lower ends of the earpiece parts, and the electrical stimulation parts are coupled by being inserted through the coupling holes.

According to the present disclosure, desirably, the electrical stimulation parts each comprises a battery and have a charging port configured to charge the battery.

According to the present disclosure, desirably, a seating part is arranged around the electrode of each of the electrical stimulation parts, and a first seating groove is located between the seating part and the electrode.

According to the present disclosure, desirably, a second seating groove seated on a mastoid process is arranged in each of the earpiece parts to which the electrical stimulation parts are coupled.

According to the present disclosure, desirably, catching holes are arranged on side surfaces of the earpiece parts to which the electrical stimulation parts are coupled, and catching projections that fit into the catching holes are arranged on the electrical stimulation parts.

According to the present disclosure, desirably, the catching holes are arranged in plurality to be spaced apart from each other along a longitudinal direction of the earpiece parts, and the catching projections are arranged in plurality to be spaced apart from each other along a longitudinal direction of the electrical stimulation parts.

According to the present disclosure, desirably, switches connected to the control part are arranged on rear surfaces of the earpiece parts to which the electrical stimulation parts are coupled.

According to the present disclosure, desirably, the switches comprise switches configured to set a stimulation intensity, a frequency, and a pulse cycle of an electrical pulse, respectively.

According to the present disclosure, desirably, the electrical stimulation parts are installed in connection frames extending backward from the bone conduction parts, respectively.

According to the present disclosure, desirably, the connection frames are configured to be separable from the bone conduction parts.

According to the present disclosure, desirably, the bone conduction parts protrude inwardly toward the head of the user, and assembly grooves into which the bone conduction parts are coupled are arranged in the connection frames.

According to the present disclosure, desirably, communication holes are arranged in the connection frames to be located at positions opposite to the bone conduction parts with reference to the electrical stimulation parts along an extension direction.

According to the present disclosure, desirably, surfaces of the connection frames at opposite sides to the bone conduction parts, and front ends of the bone conduction parts are configured to have a convex shape to complementarily correspond to temples of the user.

According to the present disclosure, desirably, in a plan view, the connection frames are configured to extend away from each other backward from the bone conduction parts.

According to the present disclosure, desirably, a battery module is detachably coupled to each of rear ends of the earpiece parts, and a charging port is arranged in the battery module.

According to the present disclosure, desirably, a third seating groove is arranged in a portion of a surface of the battery module, the portion being in contact with a mastoid process.

According to the present disclosure, the aforementioned configuration may have effects as described below.

First, according to the present disclosure, there is provided an electrically-stimulated bone conduction headset comprising: a neck band part that surrounds, in a band shape, a back side of a head of a user; earpiece parts arranged on both ends of the neck band part and hung on ears of the user, respectively; bone conduction parts installed to be adjacent to front ends of the earpiece parts, respectively; electrical stimulation parts installed to be spaced apart from the bone conduction parts toward the back side and having an electrode installed on each of side surfaces which are in contact with skin; and a control part configured to control operations of the bone conduction parts and the electrical stimulation parts. Thus, since both bone conduction parts and electrical stimulation parts are included, a great effect in prevention and treatment of a hearing loss or tinnitus may be expected.

In addition, according to the present disclosure, electrical stimulation parts are installed to be connected to rear ends of earpiece parts such that the electrical stimulation parts are in contact with a mastoid process to provide electrical stimulation. Thus, tinnitus, a hearing loss, or ear ringing may be effectively treated.

In addition, according to the present disclosure, since the electrical stimulation parts are configured to be separable from the earpiece parts, when the electrical stimulation parts are in a separate state, only a function of bone conduction earphones may be performed, and when an abnormality occurs in the electrical stimulation parts, the electrical stimulation parts may be individually separated to allow maintenance such as a repair.

In addition, according to the present disclosure, coupling holes are arranged at lower ends of the earpiece parts in a vertical direction, respectively, the electrical stimulation parts are inserted and coupled through the coupling holes, and the electrical stimulation parts each include a battery, and have a charging port configured to charge the battery and installed therein. Thus, the battery may be safely protected by being inserted into the earpiece parts through the coupling holes. In addition, the battery for operating the electrical stimulation parts may be charged separately, thus allowing easy charging.

In addition, according to the present disclosure, a seating part is placed around an electrode of each of the electrical stimulation parts, and a first seating groove is arranged between the electrode and the seating part so that the seating part is seated to face the mastoid process. Thus, electric stimulation may be effectively transmitted.

In addition, according to the present disclosure, since a second seating groove seated on the mastoid process is located in each of the earpiece parts to which the electrical stimulation parts are coupled, even when the electrical stimulation parts are separated from the earpiece parts, a state of unstable contact with the mastoid process may be avoided.

In addition, according to the present disclosure, catching holes are arranged on side surfaces of the earpiece parts to which the electrical stimulation parts are coupled, and catching projections that fit into the catching holes are arranged on the electrical stimulation parts. Thus, when the electrical stimulation parts are coupled through the coupling holes at lower ends of the earpiece parts, the catching holes and the catching projection are coupled to each other through one-touch connection by being caught and creating a click, thereby allowing easy coupling of the electrical stimulation parts.

In addition, according to the present disclosure, switches connected to the control part are arranged on rear surfaces of the earpiece parts to which the electrical stimulation parts are coupled. Thus, parameters such as a stimulation intensity, a frequency, and a pulse cycle of an electric pulse may be set according to an intended use.

In addition, according to the present disclosure, since the electrical stimulation parts have characteristics of being installed in connection frames extending backward from the bone conduction parts, respectively, an electrode may transmit electrical stimulation to a tragus nerve. Thus, an effect in various symptoms such as ear ringing and a hearing loss as well as tinnitus may be obtained.

In addition, according to the present disclosure, since the connection frames have characteristics of being configured to be separable from the bone conduction parts, only a function of a bone conduction earphone may be performed in a state when the electrical stimulation parts are in a separate state. In addition, when an abnormality occurs in the electrical stimulation parts, the electrical stimulation parts may be individually separated to allow maintenance such as a repair.

In addition, according to the present disclosure, the bone conduction parts protrude inwardly toward a head of a user, and assembly grooves into which the bone conduction parts are coupled are arranged in the connection frames. Thus, protruding portions of the bone conduction parts are coupled to the assembly grooves, and the connection frames may freely rotate around the bone conduction parts, thereby allowing adjustment for application to different bodies. In addition, since external sound may be heard through ear holes via communication holes located in the connection frames, a risk of safety accidents may be avoided.

In addition, according to the present disclosure, surfaces of the connection frames at opposite sides to the bone conduction parts, and front ends of the bone conduction parts may be configured to have a convex shape to correspond to temples of the user to further come in close contact with skin. Thus, an effect of transmitting bone conduction sound may be improved.

In addition, according to the present disclosure, a battery module is detachably coupled to each of rear ends of the earpiece parts, and a charging port is located in the battery module. Thus, attachment or detachment of the battery module may be easily performed, and since the battery module having a relatively large weight is arranged near a center of gravity, stability is increased. Thus, the electrically-stimulated bone conduction headset may be prevented from being easily detached from a head.

### BRIEF DESCRIPTION OF THE DRAWINGS

FIG. 1 is a perspective view illustrating an electrically-stimulated bone conduction headset according to Embodiment 1 of the present disclosure.

FIG. 2 is a plan view illustrating the electrically-stimulated bone conduction headset according to Embodiment 1 of the present disclosure.

FIG. 3 is a side view illustrating the electrically-stimulated bone conduction headset according to Embodiment 1 of the present disclosure.

FIG. 4 is a partially exploded bottom perspective view illustrating the electrically-stimulated bone conduction headset according to Embodiment 1 of the present disclosure.

FIG. 5 is a perspective view illustrating an electrically-stimulated bone conduction headset according to Embodiment 2 of the present disclosure.

FIG. 6 is a plan view illustrating the electrically-stimulated bone conduction headset according to Embodiment 2 of the present disclosure.

FIG. 7 is a side view illustrating the electrically-stimulated bone conduction headset according to Embodiment 2 of the present disclosure.

FIG. 8 is a partially exploded bottom perspective view illustrating the electrically-stimulated bone conduction headset according to Embodiment 2 of the present disclosure.

### BEST MODE FOR CARRYING OUT THE INVENTION

Hereinafter, an exemplary embodiment of the present disclosure will be described in detail with reference to the accompanying drawings.

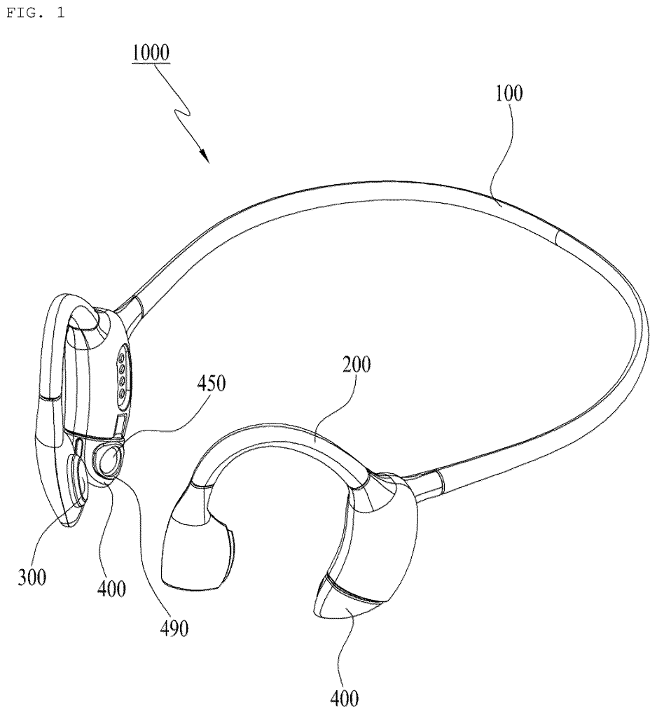

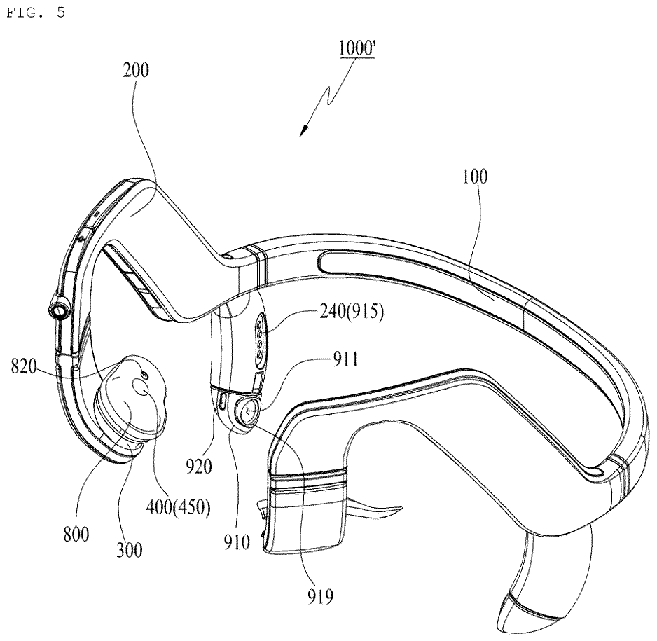

As illustrated in FIGS. 1 and 5, electrically-stimulated bone conduction headsets 1000 and 1000′ according to the present disclosure each include a neck band part 100 that surrounds, in a band shape, a back side of a head of a user, earpiece parts 200 arranged on both ends of the neck band part 100 to be hung on ears of the user, bone conduction parts 300 installed to be adjacent to front ends of the earpiece parts 200, respectively, electrical stimulation parts 400 installed to be spaced apart from the bone conduction parts 300 toward the back side and having an electrode 450 installed on each of side surfaces which are in contact with skin, respectively, and a control part, which is not shown, configured to control operations of the bone conduction parts 300 and the electrical stimulation parts 400.

According to this configuration, the electrically-stimulated bone conduction headset 1000 according to the present disclosure includes both the bone conduction parts 300 and the electrical stimulation parts 400, and thus, has such advantages that a hearing loss may be prevented by bone conduction, and tinnitus, a hearing loss, or ear ringing may be effectively treated by electrical stimulation.

Hereinafter, two embodiments are described with respect to the electrically-stimulated bone conduction headset 1000. However, the present disclosure is not limited thereto, and various embodiments and modifications may be made within the scope of the appended claims.

### Embodiment 1

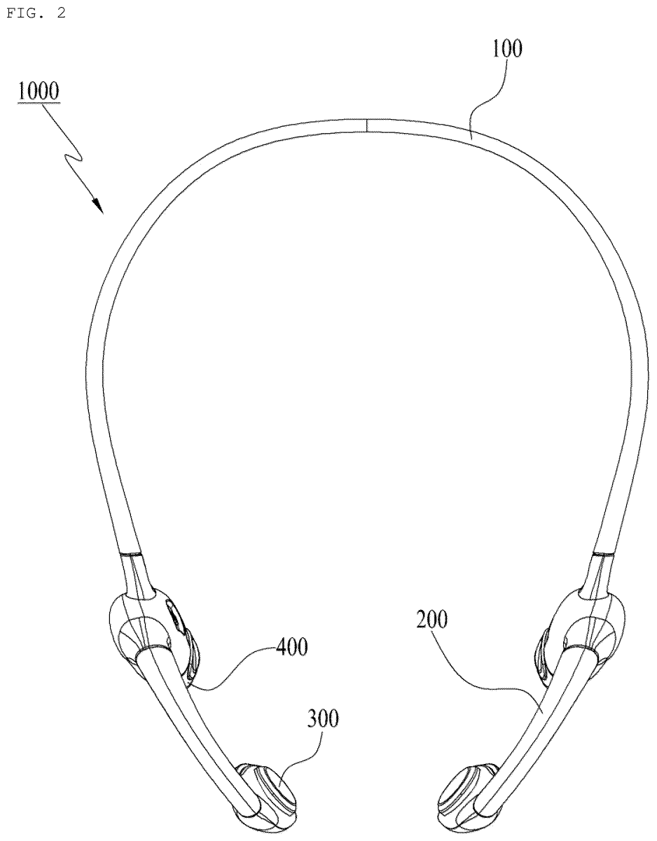

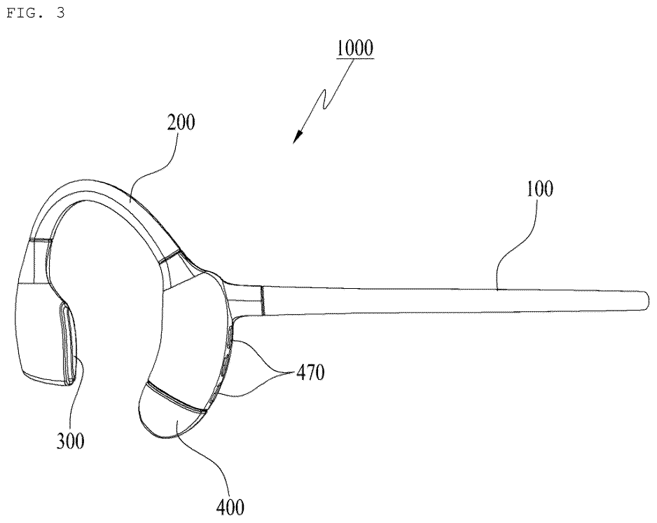

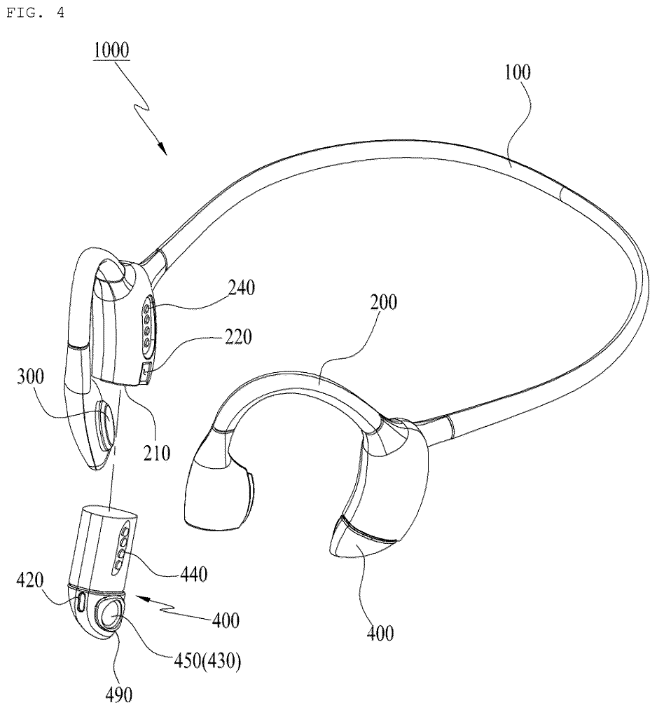

As illustrated in FIGS. 1 to 4, the electrical stimulation parts 400 according to the present disclosure are installed to be connected to rear ends of the earpiece parts 200.

Accordingly, the electrical stimulation parts 400 are in contact with a mastoid process to provide electrical stimulation, and may effectively treat tinnitus, a hearing loss, or ear ringing.

In particular, according to the present embodiment, the electrical stimulation parts 400 are configured to be separable from the earpiece parts 200.

Accordingly, when the electrical stimulation parts 400 are in a separate state, only a function of bone conduction earphones may be performed, and when an abnormality occurs in the electrical stimulation parts 400, the electrical stimulation parts 400 may be individually separated to allow maintenance such as a repair.

For example, as illustrated in the drawing, coupling holes 210 are arranged at lower ends of the earpiece parts 200 in a vertical direction, respectively, and the electrical stimulation parts 400 may be inserted through and detachably coupled to the coupling holes 210.

The electrical stimulation parts 400 each comprises a battery, which is not shown, and has a charging port 420 configured to charge the battery.

Accordingly, the battery for operating the electrical stimulation parts 400 may be charged separately, thus allowing easy charging.

In this case, it is desirable that the battery of the electrical stimulation parts 400 is inserted into the coupling holes 210 not to be exposed.

The battery may be used to operate the bone conduction parts 300, but a separate battery for operating the bone conduction parts 300 may be provided.

In this case, the separate battery may be equipped in the neck band part 100, etc.

It is desirable that a seating part 490 is arranged around the electrode 450 of each of the electrical stimulation parts 400, and a first seating groove 430 is arranged between the seating part 490 and the electrode 450 so that the seating part 490 is seated to face the mastoid process, thereby enabling electric stimulation to be effectively transmitted.

The seating part 490 may be a seating ring protruding along a circumference of the electrode 450 in a direction toward which the electrode 450 is directed or a seating edge having an inner wall surface along a circumference of the electrode 450.

That is, the seating part 490 placed around the electrode 450 and defining the first seating groove 430 is made of a rubber or silicon material. Thus, the seating part 490 around the electrode 450 is configured to be capable of being flexibly seated inside a lower end of the mastoid process of the user in a state when the electrode 450 is in contact with the mastoid process.

A conductive wire connected to the electrode 450, the control part, and the battery is equipped inside each of the earpiece parts 200 to which the electrical stimulation parts 400 are connected.

In addition, a second seating groove 220 seated on the mastoid process is arranged in each of the earpiece parts 200 to which the electrical stimulation parts 400 are coupled. Thus, even when the electrical stimulation parts 400 are separate from the earpiece parts 200, a state of unstable contact with the mastoid process may be prevented.

Catching holes 240 are arranged on side surfaces of the earpiece parts 200 to which the electrical stimulation parts 400 are coupled, and catching projections 440 that fit into the catching holes 240 may be arranged on the electrical stimulation parts 400.

According to this configuration, when the electrical stimulation parts 400 are coupled through the coupling holes 210 at lower ends of the earpiece parts 200, the catching holes 240 and the catching projection 440 are coupled to each other through one-touch connection by being caught and creating a click.

As shown in FIG. 5, the catching holes 240 are arranged in plurality to be spaced apart from each other in a vertical direction, i.e., a longitudinal direction of the earpiece parts 200, and the catching projections 440 may also be arranged in plurality to be spaced apart from each other along a longitudinal direction of the electrical stimulation parts 400.

According to this configuration, an insertion length of the electrical stimulation parts 400 through the coupling holes 210 may be adjusted, thus allowing to appropriately respond to different body structures of different users.

That is, in a state in which the catching holes 240 and the catching projections 440 are coupled to each other, when the electrical stimulation parts 400 are inserted through the coupling holes 210 to a greatest depth, the electrode 450 is located at a highest position, and when the electrical stimulation parts 400 are inserted through the coupling holes 210 to a smallest depth, the electrode 450 is at a lowest position.

In this case, the electrical stimulation parts 400 are configured to allow electrical and/or communication connections with the control part and switches even when an insertion position of the electrical stimulation parts 400 is changed.

Switches 470 connected to the control part may be arranged on rear surfaces of the earpiece parts 200 to which the electrical stimulation parts 400 are coupled.

In this case, the switches 470 may include switches configured to set various parameters such as a stimulation intensity, a frequency, and a pulse cycle of an electric pulse for tinnitus treatment, respectively.

The control part such as a printed circuit board may be equipped inside the earpiece parts 200 in which the electrical stimulation parts 400 are installed, or placed inside cases in which the bone conduction parts 300 are equipped.

### Embodiment 2

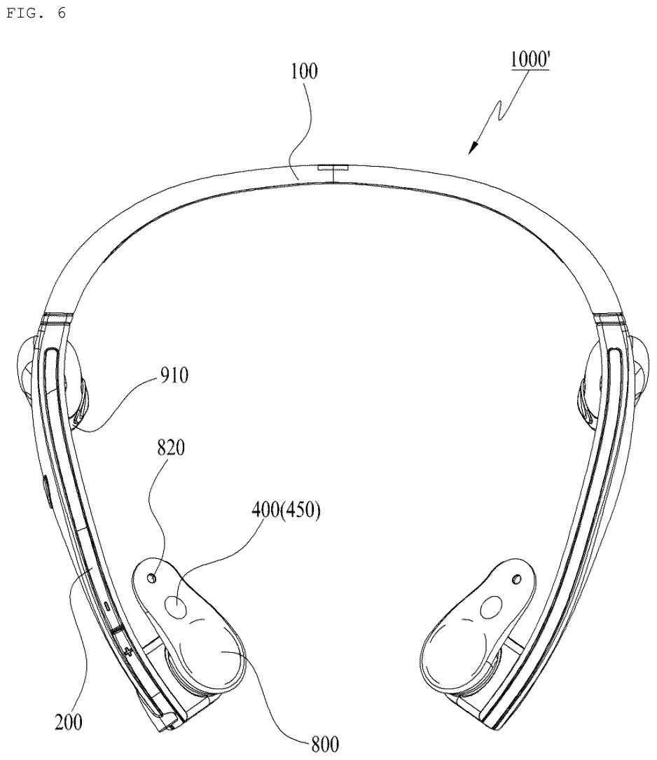

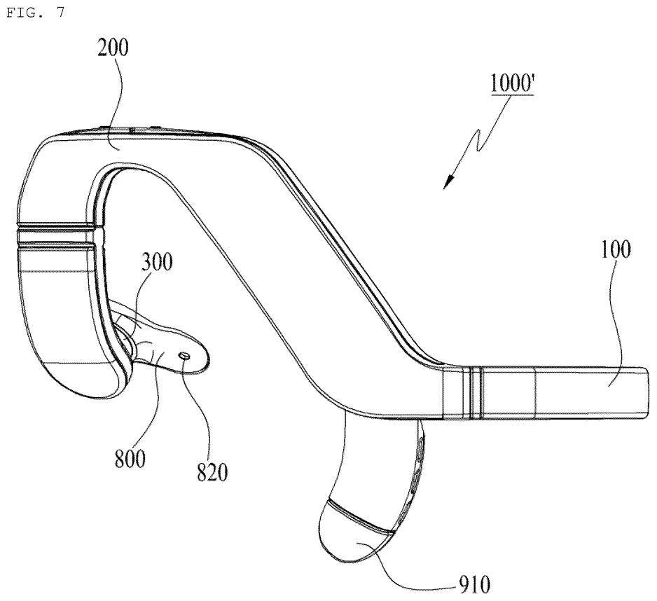

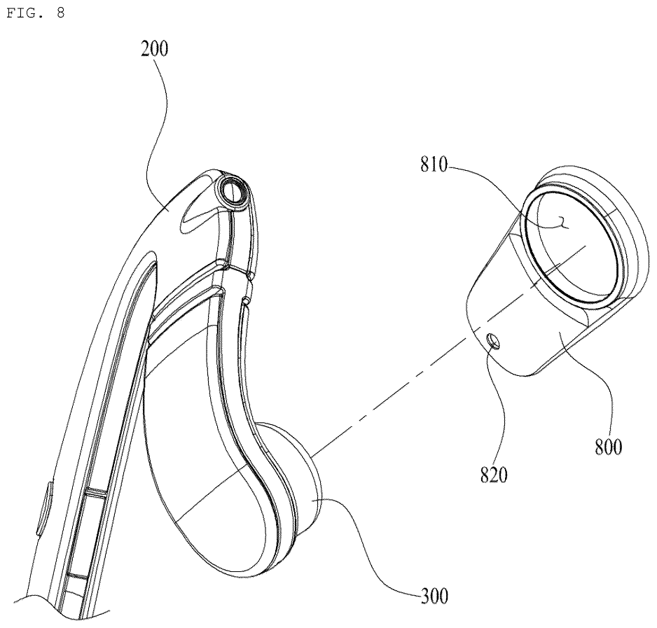

As shown in FIGS. 5 to 8, in describing the electrically-stimulated bone conduction headset 1000′ in Embodiment 2, same components as those in Embodiment 1 may be provided with same reference numerals, and a description thereof will not be provided here again.

First, according to the present embodiment, the electrical stimulation parts 400 are installed in connection frames 800 extending backward from the bone conduction parts 300, respectively.

That is, the connection frames 800 extend backward with reference to the bone conduction parts 300, and the electrical stimulation parts 400 including the electrode 450 are installed in positions spaced apart from the bone conduction parts 300.

A conductive wire connected to the electrode 450, the control part, and the battery is equipped inside the connection frames 800.

The electrode 450 may be desirably in contact with a tragus nerve area of the user to transmit electrical stimulation, but the present disclosure is not necessarily limited thereto.

Electrical stimulation may be effective in various symptoms including tinnitus as well as ear ringing and a hearing loss, and also in pain relief.

Additionally, the connection frames 800 may be configured to be separable from the bone conduction parts 300.

Accordingly, when the electrical stimulation parts 400 are in a separate state, only a function of bone conduction earphones may be performed, and when an abnormality occurs in the electrical stimulation parts 400, the electrical stimulation parts 400 may be individually separated to allow maintenance such as a repair.

The bone conduction parts 300 protrude inwardly toward the head of the user, and assembly grooves 810 into which the bone conduction parts 300 are coupled are arranged in the connection frames 800. Thus, protruding portions of the bone conduction parts 300 are coupled to the assembly grooves 810, and the connection frames 800 may freely rotate around the bone conduction parts 300, thereby allowing adjustment for application to different bodies.

Surfaces of the connection frames 800 at opposite sides to the assembly grooves 810, i.e., opposite sides to the bone conduction parts 300, and front ends of the bone conduction parts 300 may be desirably configured to have a slightly convex shape to correspond to concave temples of the user to maximize a contact area and provide a stable support.

In particular, communication holes 820 are arranged in the connection frames 800 to be located at positions opposite to the bone conduction parts 300 with reference to the electrical stimulation parts 400 along an extension direction. Thus, the connection frames 800 which extend are more stably supported by a body of the user, and further, ambient sound may be heard through the communication holes 820. Accordingly, a risk of safety accidents may be easily avoided.

As illustrated in the drawing, end portions of the bone conduction parts 300 may be desirably configured to have a convex shape toward the temples of the user to complementarily correspond to the temples to be thereby in close contact with the body of the user even when the connection frames 800 are separated, thus allowing to smoothly perform a bone conduction function.

In a plan view, the connection frames 800 may be desirably configured to extend away from each other backward from the bone conduction parts 300, respectively, to be thereby naturally in contact with the temples of the user to the mastoid process.

A battery module 910 is detachably coupled to each of rear ends of the earpiece parts 200, and a charging port 920 may be placed in the battery module 910.

Accordingly, attachment or detachment of the battery module 910 may be easily performed, and since the battery module 910 having a relatively large weight is arranged near a center of gravity, stability may be increased. Thus, the electrically-stimulated bone conduction headset 1000′ may be prevented from being easily detached from a head.

An auxiliary seating part 919 made of a flexible material similar to that of the seating part 490 of Embodiment 1 is arranged on a portion which is on a surface of the battery module 910 and in contact with the mastoid process. A third seating groove 911 is defined by the auxiliary seating part 919 and a bottom arranged therein to correctly fit the mastoid process, thereby preventing any inconvenience during use.

The catching holes 240 are arranged on a side surface of each of the earpiece parts 200 to which the battery module 910 is coupled, and the catching projections 915 that fit into the catching holes 240 may be arranged on the battery module 910.

The embodiments of the present disclosure are only examples, and it will be understood by those of ordinary skill in the art that various changes and equivalents in the form and details may be made therein without departing from the spirit and scope of the present disclosure

1. An electrically-stimulated bone conduction headset comprising:
a neck band part that surrounds, in a band shape, a back side of a head of a user;
earpiece parts arranged on both ends of the neck band part and hung on ears of the user, respectively;
bone conduction parts installed to be adjacent to front ends of the earpiece parts, respectively;
electrical stimulation parts installed to be spaced apart from the bone conduction parts toward the back side and having an electrode installed on each of side surfaces which are in contact with skin; and
a control part configured to control operations of the bone conduction parts and the electrical stimulation parts.

2. The electrically-stimulated bone conduction headset of claim 1, wherein the electrical stimulation parts are installed to be connected to rear ends of the earpiece parts.

3. The electrically-stimulated bone conduction headset of claim 2, wherein the electrical stimulation parts are configured to be separable from the earpiece parts.

4. The electrically-stimulated bone conduction headset of claim 3, wherein coupling holes are arranged in a vertical direction at lower ends of the earpiece parts, and the electrical stimulation parts are coupled by being inserted through the coupling holes.

5. The electrically-stimulated bone conduction headset of claim 4, wherein the electrical stimulation parts each comprises a battery and has a charging port configured to charge the battery.

6. The electrically-stimulated bone conduction headset of claim 1, wherein a seating part is arranged around the electrode of each of the electrical stimulation parts, and a first seating groove is located between the seating part and the electrode.

7. The electrically-stimulated bone conduction headset of claim 6, wherein a second seating groove seated on a mastoid process is arranged in each of the earpiece parts to which the electrical stimulation parts are coupled.

8. The electrically-stimulated bone conduction headset of claim 3, wherein catching holes are arranged on side surfaces of the earpiece parts to which the electrical stimulation parts are coupled, and catching projections that fit into the catching holes are arranged on the electrical stimulation parts.

9. The electrically-stimulated bone conduction headset of claim 8, wherein the catching holes are arranged in plurality to be spaced apart from each other along a longitudinal direction of the earpiece parts, and the catching projections are arranged in plurality to be spaced apart from each other along a longitudinal direction of the electrical stimulation parts.

10. The electrically-stimulated bone conduction headset of claim 3, wherein switches connected to the control part are arranged on rear surfaces of the earpiece parts to which the electrical stimulation parts are coupled.

11. The electrically-stimulated bone conduction headset of claim 10, wherein the switches comprise switches configured to set a stimulation intensity, a frequency, and a pulse cycle of an electrical pulse, respectively.

12. The electrically-stimulated bone conduction headset of claim 1, wherein the electrical stimulation parts are installed in connection frames extending backward from the bone conduction parts, respectively.

13. The electrically-stimulated bone conduction headset of claim 12, wherein the connection frames are configured to be separable from the bone conduction parts.

14. The electrically-stimulated bone conduction headset of claim 13, wherein the bone conduction parts protrude inwardly toward the head of the user, and assembly grooves into which the bone conduction parts are coupled are arranged in the connection frames.

15. The electrically-stimulated bone conduction headset of claim 12, wherein communication holes are arranged in the connection frames to be located at positions opposite to the bone conduction parts with reference to the electrical stimulation parts along an extension direction.

16. The electrically-stimulated bone conduction headset of claim 13, wherein surfaces of the connection frames at opposite sides to the bone conduction parts, and front ends of the bone conduction parts are configured to have a convex shape to complementarily correspond to temples of the user.

17. The electrically-stimulated bone conduction headset of claim 14, wherein, in a plan view, the connection frames are configured to extend away from each other backward from the bone conduction parts.

18. The electrically-stimulated bone conduction headset of claim 17, wherein a battery module is detachably coupled to each of rear ends of the earpiece parts, and a charging port is arranged in the battery module.

19. The electrically-stimulated bone conduction headset of claim 18, wherein a third seating groove is arranged in a portion of a surface of the battery module, the portion being in contact with a mastoid process.
